(19) United States
(12) Patent Application Publication
(10) Pub. No.: US 2022/0255752 A1
(43) Pub. Date: Aug. 11, 2022

(54) VEHICLE COMPUTING DEVICE AUTHENTICATION

(71) Applicant: Ford Global Technologies, LLC, Dearborn, MI (US)

(72) Inventors: Xin Ye, Farmington Hills, MI (US); Adam Mistick, Detroit, MI (US); Daniel Aaron Zajac, Carleton, MI (US); Kevin Thomas Hille, Plymouth, MI (US)

(73) Assignee: Ford Global Technologies, LLC, Dearborn, MI (US)

(21) Appl. No.: 17/171,239

(22) Filed: Feb. 9, 2021

(51) Int. Cl. H04L 9/32; B60W 50/02; H04L 29/06

(52) U.S. Cl. CPC H04L 9/3242; H04L 9/3271; H04L 2012/40215; H04L 63/1441; B60W 2050/021; B60W 50/0205

(57) ABSTRACT

An onboard communication network of a vehicle is monitored to detect a request message that includes a first cipher based message authentication code (CMAC) and a request. A challenge message is determined based on the request message. The challenge message includes a counter and a random number output from a random number generator. A second CMAC is generated based on the challenge message and the request. The request message is authenticated based on determining that the second CMAC matches the first CMAC. The vehicle is operated based on the authenticated request message.

### BACKGROUND

Vehicles can be equipped with computers, networks, sensors, and/or controllers to acquire data regarding the vehicle's environment and/or to operate vehicle components. Vehicle sensors can provide data about a vehicle's environment, e.g., concerning routes to be traveled and objects in the vehicle's environment to be avoided. Various computing devices or controllers such as electronic control units (ECUs) can be provided in a vehicle and can communicate via a vehicle network. Messages sent and received via the vehicle network can relate to operating the vehicle, and can include sensor data, actuation commands, fault reports, etc. A vehicle computing device can operate a vehicle and make real-time decisions based on data received from sensors and/or computing devices.

### BRIEF DESCRIPTION OF THE DRAWINGS

FIG. 1 is a block diagram illustrating an example vehicle control system for a vehicle.

FIG. 2A is a block diagram illustrating an example message.

FIG. 2B is a block diagram illustrating an example permutation program.

FIG. 2C is a block diagram illustrating an example challenge message.

FIG. 3 is a flowchart of an example process for generating a first cipher based message authentication code (CMAC) in a first vehicle computing device.

FIG. 4 is a flowchart of an example process for authenticating the first vehicle computing device.

### DETAILED DESCRIPTION

A system includes a computer including a processor and a memory, the memory storing instructions executable by the processor to monitor an onboard communication network of a vehicle to detect a request message that includes a first cipher based message authentication code (CMAC) and a request. The instructions further include instructions to identify a challenge message based on the request message. The challenge message includes a counter and a random number output from a random number generator. The instructions further include instructions to generate a second CMAC based on the challenge message and the request. The instructions further include instructions to authenticate the request message based on determining that the second CMAC matches the first CMAC. The instructions further include instructions to operate the vehicle based on the authenticated request message.

The second CMAC can be generated by inputting the challenge message and the request to a cryptographic program that encodes the challenge message and the request based on an authentication key.

The instructions can further include instructions to ignore the request message based on determining that the second CMAC does not match the first CMAC.

The instructions can further include instructions to identify an onboard computing device associated with the request message as an intruder device based on determining that the second CMAC does not match the first CMAC.

The instructions can further include instructions to prevent communication with the intruder device.

The instructions can further include instructions to, based on a timer expiring, generate the challenge message and provide the challenge message via the onboard communications network.

The instructions can further include instructions to update the challenge message by incrementing the counter after providing the challenge message via the onboard communications network.

The system can include an onboard computing device including a second processor and a second memory storing instructions executable by the second processor to monitor the onboard communication network to detect the challenge message. The instructions can further include instructions to, upon detecting the challenge message, generate the first CMAC by inputting the challenge message and the request to a cryptographic program that encodes the challenge message and the request based on an authentication key. The instructions can further include instructions to then generate the request message and provide the request message via the onboard communication network.

The instructions can further include instructions to store a plurality of challenge messages including respective counters. The instructions can further include instructions to determine the challenge message based on determining that a counter included in the request message matches the counter included in one stored challenge message.

The instructions can further include instructions to ignore the request message based on determining that the counter included in the request message does not match the counter included in any stored challenge message.

The instructions can further include instructions to actuate one or more vehicle components to perform the request included in the authenticated request message.

The instructions can further include instructions to initiate communication with an onboard computing device associated with the authenticated request message.

A method includes monitoring an onboard communication network of a vehicle to detect a request message that includes a first cipher based message authentication code (CMAC) and a request. The method further includes identifying a challenge message based on the request message. The challenge message includes a counter and a random number output from a random number generator. The method further includes generating a second CMAC based on the challenge message and the request. The method further includes authenticating the request message based on determining that the second CMAC matches the first CMAC. The method further includes operating the vehicle based on the authenticated request message.

The second CMAC can be generated by inputting the challenge message and the request to a cryptographic program that encodes the challenge message and the request based on an authentication key.

The method can further include ignoring the request message based on determining that the second CMAC does not match the first CMAC.

The method can further include, based on a timer expiring, generating the challenge message and provide the challenge message via the onboard communications network.

The method can further include monitoring the onboard communication network to detect the challenge message. The method can further include, upon detecting the challenge message, generating the first CMAC by inputting the challenge message and the request to a cryptographic program that encodes the challenge message and the request based on an authentication key. The method can further include then generating the request message and providing the request message via the onboard communication network.

The method can further include storing a plurality of challenge messages including respective counters. The method can further include determining the challenge message based on determining that a counter included in the request message matches the counter included in one stored challenge message.

The method can further include ignoring the request message based on determining that the counter included in the request message does not match the counter included in any stored challenge message.

The method can further include actuating one or more vehicle components to perform the request included in the authenticated request message.

Further disclosed herein is a computing device programmed to execute any of the above method steps. Yet further disclosed herein is a computer program product, including a computer readable medium storing instructions executable by a computer processor, to execute an of the above method steps.

A first vehicle computing device can provide a request message to a second vehicle computing device. The request message can include a request, a challenge message, and a first cipher based message authentication code (CMAC). Upon receiving the request message, the second vehicle computing device can encode the request and the challenge message to generate a second CMAC. If the second CMAC matches the first CMAC, then the second vehicle computing device authenticates the request message, which provides a safeguard against a possibility of the second computing device acting on false data.

As disclosed herein, it is possible to reduce risk that vehicle computing devices will send, receive, and/or act on false, e.g., spoofed by an attacker, data, which is data injected into the vehicle communication network by an unauthorized source (i.e., a source other than one of the vehicle sensors or other authorized computing devices on a vehicle communication network). For example, during vehicle operations, data captured by sensors are included in messages received by vehicle computing devices. Based on the data, the vehicle computing devices can generate control signals to vehicle components that carry out vehicle operations. Difficulties can arise, however, if the data provided to the vehicle computing devices are not authentic. An example of inauthentic data may include data presented to the vehicle computing devices via an injection attack. An injection attack occurs when false data (e.g., data that is different from the data detected by the vehicle sensors) are maliciously uploaded to the vehicle communication network.

Advantageously, upon receiving a challenge message from a second vehicle computing device, a first vehicle computing device can generate a first CMAC based on the challenge message and a request. The first vehicle computing device then provides a request message including the request, the first CMAC, and the challenge message to the second vehicle computing device. The second vehicle computing device can generate a second CMAC based on the challenge message and the request. The second vehicle computing device can authenticate the request message based on the first CMAC matching the second CMAC, which can reduce the likelihood of the second vehicle computing device operating the vehicle based on data from an unauthorized source.

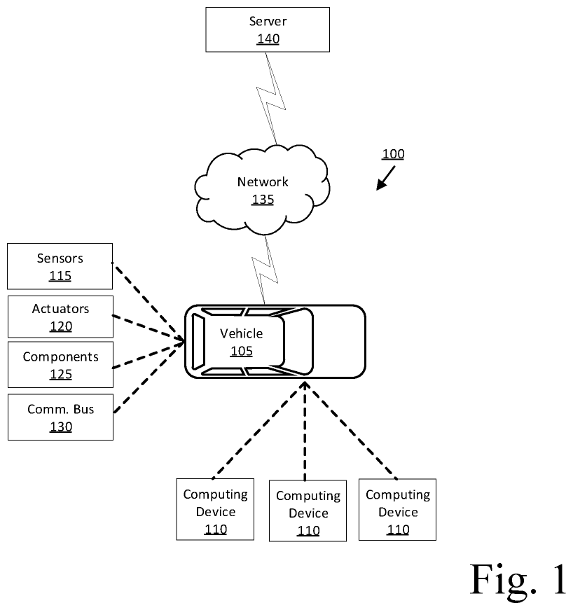

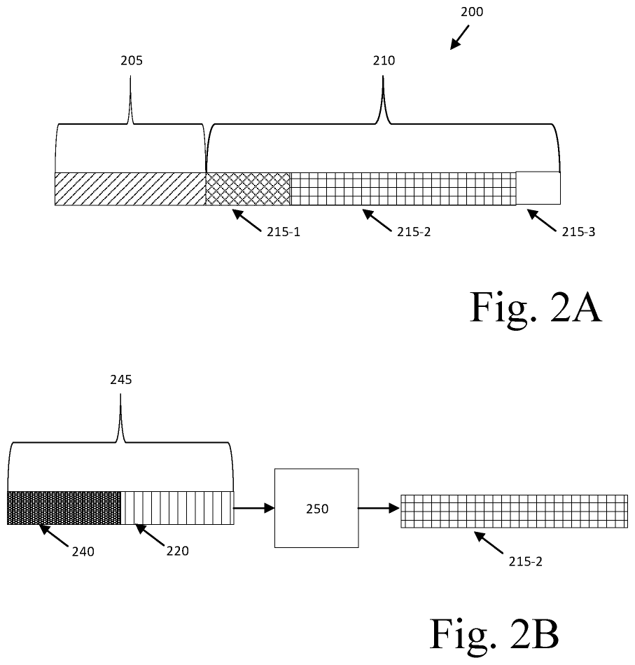

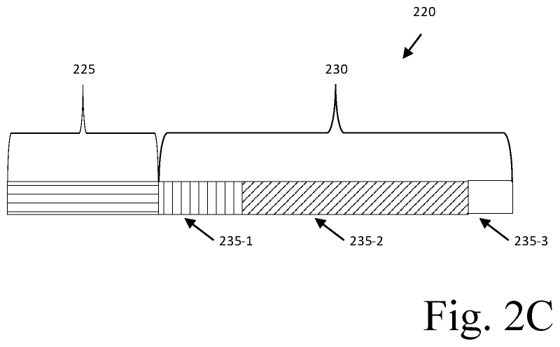

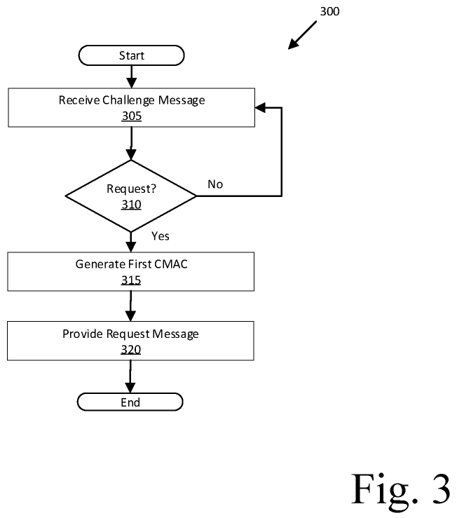

With reference to FIGS. 1-2, an example vehicle control system 100 includes a vehicle 105. A plurality of vehicle computing devices 110 in the vehicle 105 receive data from sensors 115. A vehicle computing device 110 is programmed to monitor an onboard communication network of the vehicle 105 to detect a request message 200 that includes a first cipher based message authentication code (CMAC) and a request 240. The vehicle computing device 110 is further programmed to determine a challenge message 220 based on the request message 200. The challenge message 220 includes a counter and a random number output from a random number generator. The vehicle computing device 110 is further programmed to generate a second CMAC based on the challenge message 220 and the request 240. The vehicle computing device 110 is further programmed to authenticate the request message 200 based on determining that the second CMAC matches the first CMAC. The vehicle computing device 110 is further programmed to operate the vehicle 105 based on the authenticated request message 200.

Turning now to FIG. 1, the vehicle 105 typically includes the vehicle computing devices 110, sensors 115, actuators 120 to actuate various vehicle components 125, and a vehicle communications module 130. The communications module 130 allows the vehicle computing devices 110 to communicate with a remote server computer 140, and/or other vehicles, e.g., via a messaging or broadcast protocol such as Dedicated Short Range Communications (DSRC), cellular, and/or other protocol that can support vehicle-to-vehicle, vehicle-to infrastructure, vehicle-to-cloud communications, or the like, and/or via a packet network 135.

Each vehicle computing device 110 typically includes a processor and a memory such as are known. The memory includes one or more forms of computer-readable media, and stores instructions executable by the vehicle computing device 110 for performing various operations, including as disclosed herein. Further, each vehicle computing device 110 can be a generic computer with a processor and memory as described above and/or may include a dedicated electronic circuit including an ASIC that is manufactured for a particular operation, e.g., an ASIC for processing sensor data and/or communicating the sensor data. In another example, each vehicle computing device 110 may include an FPGA (Field-Programmable Gate Array) which is an integrated circuit manufactured to be configurable by a user. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g. stored in a memory electrically connected to the FPGA circuit. In some examples, a combination of processor(s), ASIC(s), and/or FPGA circuits may be included in each vehicle computing device 110.

The vehicle computing devices 110 may operate and/or monitor the vehicle 105 in an autonomous mode, a semi-autonomous mode, or a non-autonomous (or manual) mode, i.e., can control and/or monitor operation of the vehicle 105, including controlling and/or monitoring components 125. For purposes of this disclosure, an autonomous mode is defined as one in which each of vehicle 105 propulsion, braking, and steering are controlled by the vehicle computing devices 110; in a semi-autonomous mode the vehicle computing devices 110 controls one or two of vehicle 105 propulsion, braking, and steering; in a non-autonomous mode a human operator controls each of vehicle 105 propulsion, braking, and steering.

The vehicle computing devices 110 may include programming to operate one or more of vehicle 105 brakes, propulsion (e.g., control of acceleration in the vehicle 105 by controlling one or more of an internal combustion engine, electric motor, hybrid engine, etc.), steering, transmission, climate control, interior and/or exterior lights, horn, doors, etc., as well as to determine whether and when the vehicle computing devices 110, as opposed to a human operator, are to control such operations.

The vehicle computing devices 110 may include or be communicatively coupled to, e.g., via a vehicle communication network such as a communications bus as described further below, more than one processor, e.g., a computing device 110 can be an electronic control unit (ECU) or the like included in the vehicle 105 for monitoring and/or controlling various vehicle components 125, e.g., a transmission controller, a brake controller, a steering controller, etc. The vehicle computing devices 110 are generally arranged for communications on a vehicle communication network that can include a bus in the vehicle 105 such as a controller area network (CAN) or the like, and/or other wired and/or wireless mechanisms.

Via the vehicle 105 network, each vehicle computing device 110 may transmit messages to various devices in the vehicle 105 and/or receive messages (e.g., CAN messages) from the various devices, e.g., sensors 115, an actuator 120, other vehicle computing devices 110, etc. Further, as mentioned below, various controllers and/or sensors 115 may provide data to the vehicle computing devices 110 via the vehicle communication network.

Vehicle 105 sensors 115 may include a variety of devices such as are known to provide data to the vehicle computing devices 110. For example, the sensors 115 may include Light Detection And Ranging (LIDAR) sensor(s) 115, etc., disposed on a top of the vehicle 105, behind a vehicle 105 front windshield, around the vehicle 105, etc., that provide relative locations, sizes, and shapes of objects surrounding the vehicle 105. As another example, one or more radar sensors 115 fixed to vehicle 105 bumpers may provide data to provide locations of the objects, second vehicles, etc., relative to the location of the vehicle 105. The sensors 115 may further alternatively or additionally, for example, include camera sensor(s) 115, e.g. front view, side view, etc., providing images from an area surrounding the vehicle 105. In the context of this disclosure, an object is a physical, i.e., material, item that has mass and that can be represented by physical phenomena (e.g., light or other electromagnetic waves, or sound, etc.) detectable by sensors 115. Thus, the vehicle 105, as well as other vehicles and other items including as discussed below, fall within the definition of “object” herein.

Each vehicle computing device 110 is programmed to receive data from one or more sensors 115 substantially continuously, periodically, and/or when instructed by a remote server computer 140, etc. The data may, for example, include a location of the vehicle 105. Location data specifies a point or points on a ground surface and may be in a known form, e.g., geo-coordinates such as latitude and longitude coordinates obtained via a navigation system, as is known, that uses the Global Positioning System (GPS). Additionally, or alternatively, the data can include a location of an object, e.g., a vehicle, a sign, a tree, etc., relative to the vehicle 105. As one example, the data may be image data of the environment around the vehicle 105. In such an example, the image data may include one or more objects and/or markings, e.g., lane markings, on or along a road. Image data herein means digital image data, e.g., comprising pixels with intensity and color values, that can be acquired by camera sensors 115. The sensors 115 can be mounted to any suitable location in or on the vehicle 105, e.g., on a vehicle 105 bumper, on a vehicle 105 roof, etc., to collect images of the environment around the vehicle 105.

The vehicle 105 actuators 120 are implemented via circuits, chips, or other electronic and or mechanical components that can actuate various vehicle subsystems in accordance with appropriate control signals as is known. The actuators 120 may be used to control components 125, including braking, acceleration, and steering of a vehicle 105.

In the context of the present disclosure, a vehicle component 125 is one or more hardware components adapted to perform a mechanical or electro-mechanical function or operation—such as moving the vehicle 105, slowing or stopping the vehicle 105, steering the vehicle 105, etc. Non-limiting examples of components 125 include a propulsion component (that includes, e.g., an internal combustion engine and/or an electric motor, etc.), a transmission component, a steering component (e.g., that may include one or more of a steering wheel, a steering rack, etc.), a suspension component (e.g., that may include one or more of a damper, e.g., a shock or a strut, a bushing, a spring, a control arm, a ball joint, a linkage, etc.), a brake component, a park assist component, an adaptive cruise control component, an adaptive steering component, one or more passive restraint systems (e.g., airbags), a movable seat, etc.

In addition, the vehicle computing devices 110 may be configured for communicating via a vehicle-to-vehicle communication module 130 or interface with devices outside of the vehicle 105, e.g., through a vehicle-to-vehicle (V2V) or vehicle-to-infrastructure (V2X) wireless communications (cellular and/or DSRC, etc.) to another vehicle, and/or to a remote server computer 140 (typically via direct radio frequency communications). The communications module 130 could include one or more mechanisms, such as a transceiver, by which the computers of vehicles may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the communications module 130 include cellular, Bluetooth, IEEE 802.11, dedicated short range communications (DSRC), cellular V2X (CV2X), and/or wide area networks (WAN), including the Internet, providing data communication services. For convenience, the label “V2X” is used herein for communications that may be vehicle-to-vehicle (V2V) and/or vehicle-to-infrastructure (V2I), and that may be provided by communication module 130 according to any suitable short-range communications mechanism, e.g., DSRC, cellular, or the like.

The network 135 represents one or more mechanisms by which a vehicle computing device 110 may communicate with remote computing devices, e.g., the remote server computer 140, a remote vehicle computing device, etc. Accordingly, the network 135 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth®, Bluetooth® Low Energy (BLE), IEEE 802.11, vehicle-to-vehicle (V2V) such as Dedicated Short Range Communications (DSRC), etc.), local area networks (LAN) and/or wide area networks (WAN), including the Internet, providing data communication services.

The remote server computer 140 can be a conventional computing device, i.e., including one or more processors and one or more memories, programmed to provide operations such as disclosed herein. Further, the remote server computer 140 can be accessed via the network 135, e.g., the Internet, a cellular network, and/or or some other wide area network.

The plurality of vehicle computing devices 110 in the control system 100 can authenticate request messages 200. The vehicle 105 can include other ECUs or computing devices, including on the vehicle network, that do not authenticate request messages 200. The vehicle computing devices 110 can be programmed to monitor the vehicle communication network to detect a challenge message 220 from another vehicle computing device 110. For example, a first vehicle computing device 110 can receive, via the vehicle communication network, one or more challenge messages 220 from a second vehicle computing device 110. The challenge messages 220 include a counter and a random number, as discussed further below.

The first vehicle computing device 110 can generate a request 240, i.e., a query for data or a command, e.g., based on sensor 115 data. For example, the first vehicle computing device 110 can obtain sensor 115 data from one or more sensors 115 monitoring one or more vehicle components 125. As is known, the first vehicle computing device 110 can be programmed to then encode and serialize, i.e., convert to a string of bits, data, such as data describing objects, data describing vehicle 105 operating conditions such as speed, heading, etc., data about a vehicle's 105 planned route, etc., so that the data can be included as the request 240 in the request message 200. Prior to generating the request 240, the first vehicle computing device 110 can ignore any detected challenge messages 220 from the second vehicle computing device 110. After generating the request 240, the first vehicle computing device 110 can select a challenge message 220 detected via the vehicle communication network.

The first vehicle computing device 110 is programmed to generate a request message 200 based on the selected challenge message 220 and the request 240. A request message 200 typically includes a header 205 and a payload 210 (see FIG. 2A). The header 205 may include a source identifier, e.g., a string of bits that identifies the vehicle computing device 110 that generated the request message 200, a message type, a message size, etc. The payload 210 may include various data, i.e., message content. The payload can include sub-payloads or payload segments 215-1, 215-2, 215-3 (collectively, referred to as payload segments 215). The respective payload segments 215 in FIG. 2A are illustrated as being of different lengths to reflect that different payload segments 215 may include various amounts of data, and therefore may be of different sizes.

The payload 210 of the request message 200 includes the request 240. Upon generating the request 240, the first vehicle computing device 110 can include the request 240 in the payload 210, e.g., a specified payload segment 215, of the request message 200. Additionally, the payload 210 of the request message 200 includes the selected challenge message 220. For example, the first vehicle computing device 110 can include the selected challenge message 220 in the payload 210, e.g., a specified payload segment 215, of the request message 200. Alternatively, the first vehicle computing device 110 can include a portion of the selected challenge message 220, e.g., the counter or the random number, in the payload 210, e.g., a specified payload segment 215, of the request message 200. As one example, the first vehicle computing device 110 can identify the counter in the selected challenge message 220, e.g., based on a specified payload segment 235 (as discussed below) of the selected challenge message 220. For example, the first vehicle computing device 110 can access the specified payload segment 235 of the selected challenge message 220 and retrieve the counter. The first vehicle computing device 110 can then include the counter in the payload 210, e.g., a specified payload segment 215, of the request message 200.

Additionally, the payload 210 of the request message 200 includes a first CMAC. The first vehicle computing device 110 can generate the first CMAC based on the request 240 and the selected challenge message 220. A CMAC is unique for each request message 200 because each challenge message 220 is unique. That is, different CMACs are generated for different challenge messages 220. Specifically, each challenge message 220 is generated by incrementing the counter and/or by generating a random number. Accordingly, each challenge message 220 varies from previous challenge messages 220, i.e., either the counter is incremented for each subsequent challenge message 220 and/or a new random number is generated for each subsequent challenge message 220. Therefore, the CMACs generated from the challenge messages 220 will be different.

Upon generating the first CMAC, the first vehicle computing device 110 can include the first CMAC in the payload 210, e.g., a specified payload segment 215, of the request message 200. In one example, the first vehicle computing device 110 can truncate the first CMAC based on a length of the specified payload segment 215. That is, the first vehicle computing device 110 can remove a portion of the first CMAC such that a length of the truncated first CMAC is equal to the length of the specified payload segment 215. The specified payload segment 215, including the corresponding length, can be stored, e.g., in respective memories of the vehicle computing devices 110.

To generate the first CMAC, the first vehicle computing device 110 can input a first input message 245 and an authentication key to a permutation program 250 that encodes the first input message 245 based on the authentication key (see FIG. 2B). The first vehicle computing device 110 can generate the first input message 245 by combining, e.g., concatenating, the selected challenge message 220 (which as discussed above can be the entire challenge message 220 or a portion thereof), and the request 240. For example, the first vehicle computing device 110 can combine the counter in the selected challenge message 220 and the request 240 to generate the first input message 245.

The permutation program 250 (sometimes called a permutation generator) can be a conventional cryptographic program, e.g., an Advanced Encryption Standard (AES) algorithm. The permutation program 250 can rearrange the data in the first input message 245 in an order that is specified by the authentication key. That is, the permutation program 250 performs, for each portion of the first input message 245, one or more of a substitution, a change of order of segments in the first input message 245, or a mathematical operation according to block ciphers generated from the authentication key. For example, if the permutation program 250 is an AES algorithm, the first vehicle computing device 110 can identify a 16-bit portion of the first input message 245, apply an “exclusive-or” function (i.e., an XOR function) between the 16-bit portion and a portion of the authentication key to generate a first round string, and arrange first round string into a 4×4 grid. Then, the first vehicle computing device 110 can perform one of (1) shift respective positions of bits within the rows of the 4×4 grid, (2) substitute one of the bits in the 4×4 grid with a known substitution bit, (3) shift respective positions of bits within the columns of the 4×4 grid, or (4) scaling values of the bits by predetermined integers. The shifting, scaling, and substitution algorithms are determined according to the specific permutation program 250. The first vehicle computing device 110 can perform the permutation program 250 for the first input message 245 to generate the first CMAC.

The first vehicle computing device 110 can retrieve the authentication key, e.g., from the memory of the first vehicle computing device 110. The authentication key is a predetermined set of alphanumeric characters. For example, the authentication key can be a cryptographic key used in a conventional cryptographic program, e.g., Diffie-Hillman exchange, RSA encryption, AES, etc. The authentication key can be specified, e.g., by a manufacturer of the vehicle 105 and/or a computing device 110. Each vehicle computing device 110 can receive the authentication key from the remote server computer 140, e.g., via the network 135, and can store the authentication key, e.g., in a respective memory.

Upon generating the request message 200, the first vehicle computing device 110 can provide the request message 200 to the second vehicle computing device 110. For example, the first vehicle computing device 110 can transmit the request message 200 to the second vehicle computing device 110, e.g., via the vehicle communication network.

As set forth above, the second vehicle computing device 110 is programmed to provide a plurality of challenge messages 220 to the first vehicle computing device 110. For example, the second vehicle computing device 110 can transmit the challenge messages 220 to the first vehicle computing device 110, e.g., via the vehicle communication network. The second vehicle computing device 110 is programmed to provide a challenge message 220 based on a timer expiring. For example, upon providing a first challenge message 220, the second vehicle computing device 110 can initiate a timer. When the timer expires, the second vehicle computing device 110 can provide an updated challenge message 220, e.g., including an incremented counter, and reset the timer. A duration of the timer is a predetermined time, e.g., 500 milliseconds, 1 second, 5 seconds, etc. The duration of the timer may be stored, e.g., in the memory of the second vehicle computing device 110. As another example, the second vehicle computing device 110 can provide an updated challenge message 220 upon generating a new random number (as discussed below).

Similar to the request message 200, the challenge message 220 includes a header 225 and a payload 230 (see FIG. 2C). The header 225 may include an identifier, e.g., a string of bits that identifies the second vehicle computing device 110, a message type, a message size, etc. The payload 230 may include various data, i.e., message content. The payload can include sub-payloads or payload segments 235-1, 235-2, 235-3 (collectively, referred to as payload segments 235). The respective payload segments 235 in FIG. 2C are illustrated as being of different lengths to reflect that different payload segments 235 may include various amounts of data, and therefore may be of different sizes. The payload 235 of the challenge message 220 includes, e.g., in specified payload segments 235, the counter and the random number.

The second vehicle computing device 110 can store the counter, e.g., in a memory of the second vehicle computing device 110. A counter is a unique identifier for the challenge message 220. The counter may, for example, indicate a number of challenge messages 220 that have been transmitted via the vehicle communication network. Upon providing a challenge message 220 on the vehicle communication network, the second vehicle computing device 110 can increment the counter stored in the respective memory. Upon incrementing the counter, the second vehicle computing device 110 can overwrite, e.g., in the memory, the counter with the incremented counter.

The random number can be generated using a random number generator. A “random number generator” is an algorithm that generates a sequence of numbers when seeded with an initial value. That is, the random number generator (RNG) is a deterministic algorithm that generates a specified sequence for each initial seed number; in the context of the present document, references to a random number generator are to what is understood in the computer arts as a “pseudo-random number generator,” i.e., a number generator that generates a sequence of numbers based on an initial seed number. Said differently, the second vehicle computing device 110 can generate a sequence of random (or pseudorandom) numbers based on the initial seed number by using the RNG. The RNG can be a conventional algorithm, e.g., a Lehmer generator, a Mersenne Twister, an Advanced Randomization System, Philox, etc. In this document, “seed” has its conventional meaning in the computer arts, i.e., in the present context, to “seed” means specifying an initial condition of the RNG algorithm, which initializes the random number generator to generate a specific sequence of numbers based on the specific initial condition, i.e., seed value.

The second vehicle computing device 110 can, for example, input a removed portion of a second CMAC (as discussed below) into the random number generator as the seed value. In such an example, the second vehicle computing device 110 can generate a new random number after generating a second CMAC. That is, upon generating a second CMAC, the second vehicle computing device can remove a portion of the second CMAC and input the removed portion to the RNG to generate a new random number. As another example, the second vehicle computing device 110 can input a current time into the random number generator as the seed value. In such an example, the second vehicle computing device 110 can generate a new random number after a predetermined time, e.g., 500 milliseconds, 1 second, 30 seconds, etc. The second vehicle computing device 110 can include the new random number in an updated challenge message 220, as set forth above.

Upon generating a challenge message 220, the second vehicle computing device 110 may store the challenge message 220, e.g., in the memory of the second vehicle computing device 110. The second vehicle computing device 110 may store a plurality of challenge messages 220. When the second vehicle computing device 110 has stored a specified number of challenge messages 220, e.g., four, eight, sixteen, etc., the second vehicle computing device 110 is programmed to overwrite an oldest in time stored challenge message 220 with a subsequently generated challenge message 220. The stored challenge messages 220 may be included in a look-up table, or the like. The number of stored challenge messages 220 may be specified by a vehicle 105 and/or component 125 manufacturer and stored in a memory of the second vehicle computing device 110.

The second vehicle computing device 110 is programmed to monitor the vehicle communication network to detect a request message 200 (as discussed above) from another vehicle computing device 110. For example, the second vehicle computing device 110 can receive, via the vehicle communication network, one or more request messages 200 from the first vehicle computing device 110.

Upon receiving the request message 200, the second vehicle computing device 110 can identify the selected challenge message 220 based on the request message 200. For example, the second vehicle computing device 110 can identify a challenge message 220 included in the request message 200 in the request message 200, e.g., based on the specified payload segment 215. For example, the second vehicle computing device 110 can access the specified payload segment 215 and retrieve the challenge message 220 included in the request message 200. The second vehicle computing device 110 can then compare the challenge message 220 included in the request message 200 to the plurality of stored challenge messages 220. The second vehicle computing device 110 identifies the selected challenge message 220 based on the challenge message 220 included in the request message 200 matching a stored challenge message 220. If the challenge message 220 included in the request message 200 does not match any stored challenge messages 220, then the second vehicle computing device 110 can ignore the request message 200. Additionally, or alternatively, the second vehicle computing device 110 can identify the first vehicle computing device 110 as an intruder device. As used herein, an “intruder device” is a computing device that is not authorized to access the vehicle communication network, e.g., to share data with the vehicle computing devices 110, sensors 115, etc. on the vehicle communication network.

As another example, the second vehicle computing device 110 can identify a portion of the challenge message 220, e.g., the counter, in the request message 200, e.g., based on the specified payload segment 215. For example, the second vehicle computing device 110 can access the specified payload segment 215 and retrieve a counter. The second vehicle computing device 110 can then compare the counter included in the request message 200 to the respective counters included in the plurality of stored challenge messages 220. The second vehicle computing device 110 identifies the selected challenge message 220 based on the counter included in the request message 200 matching the counter included in a stored challenge message 220. If the counter included in the request message 200 does not match the counters in any stored challenge message 220, then the second vehicle computing device 110 can ignore the request message 200 and/or identify the first vehicle computing device 110 as an intruder device.

Additionally, the second vehicle computing device 110 can identify the request 240 in the request message 200, e.g., based on the specified payload segment 215. For example, the second vehicle computing device 110 can access the specified payload segment 215 and retrieve the request 240. The second vehicle computing device 110 can then generate a second CMAC based on the request 240 and the selected challenge message 220, e.g., in substantially the same manner as discussed above regarding the first CMAC. For example, the second vehicle computing device 110 can generate a second input message by combining, e.g., concatenating, the selected challenge message 220 and the request 240. The second vehicle computing device 110 can then input the second input message into the permutation program 250 to generate the second CMAC based on the authentication key. In situations in which the first vehicle computing device 110 truncates the first CMAC, e.g., based on a length of the specified payload segment 215, the second vehicle computing device 110 can similarly truncate the second CMAC. That is, the second vehicle computing device 110 can remove a portion of the second CMAC such that a length of the truncated second CMAC is equal to the length of the first CMAC, i.e., the length of the specified payload segment 215. After truncating the second CMAC, the second vehicle computing device 110 can input a removed portion of the second CMAC into the RNG, as discussed above.

The second vehicle computing device 110 then compares the second CMAC (which as just discussed above can be the entire second CMAC or a truncated portion thereof) to the first CMAC (which as just discussed above can be the entire first CMAC or a truncated portion thereof). If the second CMAC matches the first CMAC, then the second vehicle computing device 110 authenticates the request message 200. In this situation, the second vehicle computing device 110 may act on the authenticated request message 200 to operate the vehicle 105. For example, the second vehicle computing device 110 may initiate communication with the first vehicle computing device 110 based on the request 240 included in the authenticated request message 200. As another example, the second vehicle computing device 110 may generate control signals to actuate one or more vehicle components 125 based on the request 240 included in the authenticated request message 200, e.g., to adjust a speed, heading, etc. of the vehicle 105.

If second CMAC does not match the first CMAC, then the second vehicle computing device 110 can determine that an intruder device provided the request message 200. In this situation, the second vehicle computing device 110 ignores the request message 200, which advantageously provides a safeguard against a possibility that the second vehicle computing device 110 will act on false data. Additionally, the second vehicle computing device 110 can prevent communication between the intruder device and the second vehicle computing device 110.

FIG. 3 is a diagram of an example process 300 for generating a first CMAC. The process 300 begins in a block 305. The process 300 can be carried out by a first vehicle computing device 110 included in the vehicle 105 executing program instructions stored in a memory thereof.

In the block 305, the first vehicle computing device 110 monitors a vehicle communication network to detect a challenge message 220 from a second vehicle computing device 110. For example, the first vehicle computing device 110 can receive one or more challenge messages 220 from the second vehicle computing device 110, e.g., via the vehicle communication network. The process 300 continues in a block 310.

In the block 310, the first vehicle computing device 110 determines whether to generate a request 240. For example, the first vehicle computing device 110 can generate a request 240, e.g., to query data or to command, based on sensor 115 data, as discussed above. If the first vehicle computing device 110 generates a request 240, then the first vehicle computing device 110 selects the challenge message 220 detected on the vehicle communication network, and the process 300 continues in a block 315. If the first vehicle computing device 110 fails to generate a request 240, then the first vehicle computing device 110 ignores the challenge message 220 detected on the vehicle communication network, and the process 300 returns to the block 310.

In the block 315, the first vehicle computing device 110 generates the first CMAC based on the request 240 and the challenge message 220. For example, the first vehicle computing device 110 can generate a first input message 245 by combining, e.g., concatenating, the request 240 and the selected challenge message 220, as discussed above. The first vehicle computing device 110 can then input the first input message 245 and an authentication key, e.g., received from a memory of the first vehicle computing device 110, into a permutation program 250 that generates the first CMAC, as discussed above. Upon generating the first CMAC, the first vehicle computing device 110 can truncate the first CMAC, as discussed above. The process 300 continues in a block 320.

In the block 320, the first vehicle computing device 110 provides a request message 200 via the vehicle communication network. The first vehicle computing device 110 can generate the request message 200 by including the first CMAC (which as just discussed can be truncated), the request 240, and the challenge message 220 (which as discussed above can be the entire selected challenge message 220 or a portion thereof) in the payload 210, e.g., in specified payload segments 215, in the request message 200. Upon generating the request message 200, the first vehicle computing device 110 can transmit the request message 200 to the second vehicle computing device 110, e.g., via the vehicle communication network. The process 300 ends following the block 320.

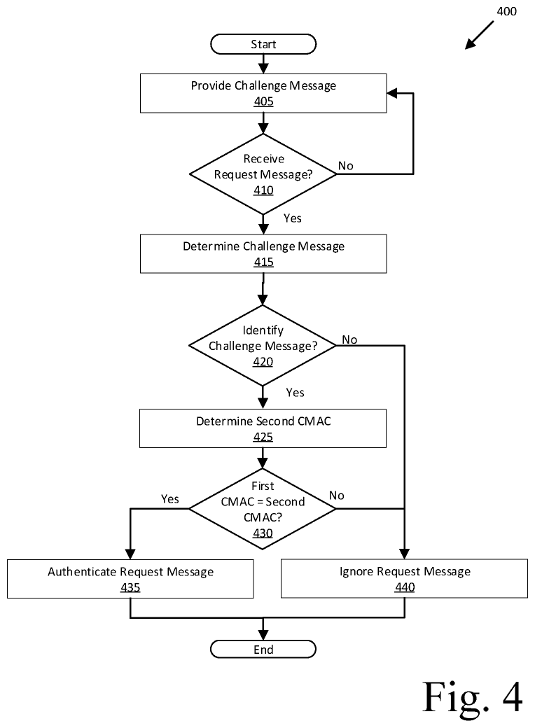

FIG. 4 is a diagram of an example process 400 for authenticating a request message 200 from a first vehicle computing device 110. The process 400 begins in a block 405. The process 400 can be carried out by a second vehicle computing device 110 included in the vehicle 105 executing program instructions stored in a memory thereof.

In the block 405, the second vehicle computing device 110 provides a plurality of challenge messages 220 to other vehicle computing devices 110 via a vehicle communication network. The challenge messages 220 include a counter and a random number. The random number can be generated using a random number generator, as discussed above. The second vehicle computing device 110 can store the counter, e.g., in a memory of the second vehicle computing device 110. The second vehicle computing device 110 can generate the challenge message 220 by including the counter and the random number in a payload 230, e.g., specified payload segments 235, of the challenge message 220, as discussed above. Upon generating the challenge message 220, the second vehicle computing device 110 can transmit the challenge message 220 to the first vehicle computing device 110, e.g., via the vehicle communication network. Additionally, the second vehicle computing device 110 stores the challenge message 220, e.g., in a look-up, as discussed above.

Upon providing a challenge message 220 on the vehicle communication network, the second vehicle computing device 110 can increment the counter stored, e.g., in the memory of the second vehicle computing device 110. The second vehicle computing device 110 can provide an updated challenge message 220 based on a timer expiring, as discussed above. For example, when the timer expires, the second vehicle computing device 110 can provide the updated challenge message 220, e.g., that includes the incremented counter. Additionally, or alternatively, the second vehicle computing device 110 can provide an updated challenge message 220 that includes a new random number based on inputting a removed portion of a second CMAC into a random number generator, as discussed above. The process 400 continues in a block 410.

In the block 410, the second vehicle computing device 110 determines whether a request message 200 has been received from a first vehicle computing device 110. The second vehicle computing device 110 can monitor the vehicle communication network to detect one or more request messages 200 from one or more other vehicle computing devices 110. For example, the second vehicle computing device 110 can receive a request message 200 from a first vehicle computing device 110. If the second vehicle computing device 110 receives the request message 200, then the process 400 continues in a block 415. Otherwise, the process 400 returns to the block 405.

In the block 415, the second vehicle computing device 110 identifies the selected challenge message 220 based on the request message 200, e.g., a specified payload segment 215. For example, the second vehicle computing device 110 can access the specified payload segment 215 of the request message 200 and retrieve a challenge message 220 included in the request message 200. The second vehicle computing device 110 can then compare the challenge message 220 included in the request message 200 to a plurality of stored challenge messages 220, as discussed above. The process 400 continues in a block 420.

In the block 420, the second vehicle computing device 110 compares the selected challenge message 220 to a plurality of stored challenge messages 220. The second vehicle computing device 110 identifies the selected challenge message 220 based on the challenge message 220 included in the request message 200 matching a stored challenge message 220. If the selected challenge message 220 matches a stored challenge message 240, then the process 400 continues in a block 425. Otherwise, the process 400 continues in a block 440.

In the block 425, the second vehicle computing device 110 generates a second CMAC based on the selected challenge message 220 and the request 240 included in the request message 200. For example, the second vehicle computing device 110 can generate a second input message by combining, e.g., concatenating, the selected challenge message 220 and the request 240. The second vehicle computing device 110 can then input the second input message and an authentication key, e.g., received from a memory of the second vehicle computing device 110, into a permutation program 250 that generates the second CMAC, as discussed above. Upon generating the second CMAC, the second vehicle computing device 110 can truncate the second CMAC, as discussed above. The process 400 continues in a block 425.

In the block 430, the second vehicle computing device 110 compares the first CMAC (which as discussed above is included in the request message 200 and can be truncated) to the second CMAC (which as discussed above can be truncated). If the first CMAC matches the second CMAC, then the process 400 continues in a block 435. Otherwise, the process 400 continues in a block 440.

In the block 435, the second vehicle computing device 110 authenticates the request message 200. In this situation, the second vehicle computing device 110 may act on the authenticated request message 200. For example, based on the request 240 included in the authenticated request message 200, the second vehicle computing device 110 may operate the vehicle 105 by initiating communication with the first vehicle computing device 110 and/or generating control signals to actuate one or more vehicle components 125, e.g., to adjust a speed, heading, etc. of the vehicle 105. The process 400 ends following the block 435.

In the block 440, the second vehicle computing device 110 ignores the request message 200. In this situation, the second vehicle computing device 110 can determine that an intruder device provided the request message 200. Additionally, the second vehicle computing device 110 can prevent communication between the intruder device and the second vehicle computing device 110. The process 400 ends following the block 440.

As used herein, the adverb “substantially” means that a shape, structure, measurement, quantity, time, etc. may deviate from an exact described geometry, distance, measurement, quantity, time, etc., because of imperfections in materials, machining, manufacturing, transmission of data, computational speed, etc.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board first computer, a computer workstation, a server, a desktop, notebook, laptop, or handheld computer, or some other computing system and/or device.

Computers and computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

Memory may include a computer-readable medium (also referred to as a processor-readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain embodiments and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system, comprising a computer including a processor and a memory, the memory storing instructions executable by the processor to:
monitor an onboard communication network of a vehicle to detect a request message that includes a first cipher based message authentication code (CMAC) and a request;
identify a challenge message based on the request message, wherein the challenge message includes a counter and a random number output from a random number generator;
generate a second CMAC based on the challenge message and the request;
authenticate the request message based on determining that the second CMAC matches the first CMAC; and
operate the vehicle based on the authenticated request message.

2. The system of claim 1, wherein the second CMAC is generated by inputting the challenge message and the request to a cryptographic program that encodes the challenge message and the request based on an authentication key.

3. The system of claim 1, wherein the instructions further include instructions to ignore the request message based on determining that the second CMAC does not match the first CMAC.

4. The system of claim 1, wherein the instructions further include instructions to identify an onboard computing device associated with the request message as an intruder device based on determining that the second CMAC does not match the first CMAC.

5. The system of claim 4, wherein the instructions further include instructions to prevent communication with the intruder device.

6. The system of claim 1, wherein the instructions further include instructions to, based on a timer expiring, generate the challenge message and provide the challenge message via the onboard communications network.

7. The system of claim 6, wherein the instructions further include instructions to update the challenge message by incrementing the counter after providing the challenge message via the onboard communications network.

8. The system of claim 6, further comprising an onboard computing device including a second processor and a second memory storing instructions executable by the second processor to:
monitor the onboard communication network to detect the challenge message;
upon detecting the challenge message, generate the first CMAC by inputting the challenge message and the request to a cryptographic program that encodes the challenge message and the request based on an authentication key; and
then generate the request message and provide the request message via the onboard communication network.

9. The system of claim 1, wherein the instructions further include instructions to:
store a plurality of challenge messages including respective counters;
determine the challenge message based on determining that a counter included in the request message matches the counter included in one stored challenge message.

10. The system of claim 9, wherein the instructions further include instructions to ignore the request message based on determining that the counter included in the request message does not match the counter included in any stored challenge message.

11. The system of claim 1, wherein the instructions further include instructions to actuate one or more vehicle components to perform the request included in the authenticated request message.

12. The system of claim 1, wherein the instructions further include instructions to initiate communication with an onboard computing device associated with the authenticated request message.

13. A method, comprising:
monitoring an onboard communication network of a vehicle to detect a request message that includes a first cipher based message authentication code (CMAC) and a request;
identifying a challenge message based on the request message, wherein the challenge message includes a counter and a random number output from a random number generator;
generating a second CMAC based on the challenge message and the request;
authenticating the request message based on determining that the second CMAC matches the first CMAC; and
operating the vehicle based on the authenticated request message.

14. The method of claim 13, wherein the second CMAC is generated by inputting the challenge message and the request to a cryptographic program that encodes the challenge message and the request based on an authentication key.

15. The method of claim 13, further comprising ignoring the request message based on determining that the second CMAC does not match the first CMAC.

16. The method of claim 13, further comprising, based on a timer expiring, generating the challenge message and provide the challenge message via the onboard communications network.

17. The method of claim 16, further comprising:
monitoring the onboard communication network to detect the challenge message;
upon detecting the challenge message, generating the first CMAC by inputting the challenge message and the request to a cryptographic program that encodes the challenge message and the request based on an authentication key; and
then generating the request message and providing the request message via the onboard communication network.

18. The method of claim 13, further comprising:
storing a plurality of challenge messages including respective counters;
determining the challenge message based on determining that a counter included in the request message matches the counter included in one stored challenge message.

19. The method of claim 18, further comprising ignoring the request message based on determining that the counter included in the request message does not match the counter included in any stored challenge message.

20. The method of claim 13, further comprising actuating one or more vehicle components to perform the request included in the authenticated request message.
